(19) United States
(12) Patent Application Publication
(10) Pub. No.: US 2021/0336255 A1
(43) Pub. Date: Oct. 28, 2021

(54) METHOD FOR PRODUCING NEGATIVE ELECTRODE MATERIAL FOR SECONDARY BATTERY

(71) Applicant: WFM INC., Seoul (KR)

(72) Inventors: Chang Hee SHIN, Gyeonggi-do (KR); Seok Won JEON, Gyeonggi-do (KR); Hwan Jin KIM, Gyeonggi-do (KR); Keun Young YOON, Incheon (KR); Shin Won RYU, Daejeon (KR); Ki Jun AHN, Chungcheongbuk-do (KR); Seung Hoon YOO, Daejeon (KR)

(21) Appl. No.: 16/490,769

(22) PCT Filed: Jul. 26, 2019
(86) PCT No.: PCT/KR2019/009369

§ 371 Date: Sep. 3, 2019

(30) Foreign Application Priority Data
May 30, 2019 (KR) 10-2019-0064021

(51) Int. Cl. H01M 4/48; H01M 4/04; H01M 10/0525; C01B 33/113

(52) U.S. Cl. CPC H01M 4/483; H01M 4/049; H01M 2004/027; C01B 33/113; H01M 10/0525

(57) ABSTRACT

The present disclosure relates to a method for producing a negative electrode material for a secondary battery having excellent electrochemical performance by using a silicon oxide with a low oxygen content, and a negative electrode material for a secondary battery produced by the method, a secondary battery,
wherein the method comprises a gel-forming step of introducing SiCl₄ and then ethylene glycol into a reactor at a temperature of 0° C. to 25° C. under an inert atmosphere to form a gel;
a preheating step of heating the gel to a temperature of 200° C. to 500° C.; and
a heat treatment step of heating the gel subjected to the preheating step to a temperature of 500° C. to 1100° C. to form a silicon oxide.

### TECHNICAL FIELD

The present disclosure relates to a method for producing a negative electrode material for a secondary battery. More specifically, the present disclosure relates to a method for producing a negative electrode material for a secondary battery which can provide a lithium secondary battery improved in electrochemical characteristics, comprising a silicon oxide (hereinafter referred to as “carbon-containing silicon oxide”) as a high-capacity negative electrode material. The present disclosure further relates to a negative electrode material for a secondary battery produced by said method. The present disclosure further relates to a secondary battery.

### BACKGROUND ART

As electronic devices and electric energy storage devices have become smaller, lighter, and thinner according to the IT industry developments in recent years, there has been an increasing demand for high energy density of rechargeable secondary batteries used as power sources for such electronic devices and electric energy storage devices.

In particular, a lithium secondary battery has a high energy density, so that the electrode material can provide more energy per unit mass or unit volume. As such, the lithium secondary battery is a battery that can meet the demand for high energy density. The lithium secondary battery is currently used in a portable electronic device and a communication device such as a cellular phone and a notebook computer.

The lithium secondary battery is composed of a positive electrode, a negative electrode, and an electrolyte and others. The lithium secondary battery utilizes a repetitive intercalation and extraction reaction of a lithium ion, which is also referred to as a rocking-chair system.

When the lithium secondary battery is discharged, a spontaneous oxidation reaction occurs in a negative electrode active material and a spontaneous reduction reaction occurs in a positive electrode active material. For example, a review of a graphite negative electrode and a LiCoO₂ positive electrode which are currently used as main materials for a small lithium secondary battery indicates that, in the discharging process of a lithium secondary battery consisting of LiₓC/Li₁₋ₓCoO₂, LiₓC, a negative electrode active material, supplies an electron and a lithium ion and is subjected to an oxidation reaction, while Li₁₋ₓCoO₂, a positive electrode active material, receives the electron and the lithium ion and is subjected to a reduction reaction. That is, the negative electrode plays a role of storing the lithium ion in the charging process and releasing the lithium ion in the discharging process.

Meanwhile, in order to further increase the energy density of the lithium secondary battery, research and development has been conducted to increase the capacity of the positive electrode material and the negative electrode material. However, the development of positive electrode materials has reached a certain limit, and as a result, attention has been focused on the development of negative electrode materials in recent years.

In the case of a negative electrode material for a lithium secondary battery, there is a graphite material, but considering that a high capacity battery is required, it is difficult to use the graphite material as a negative electrode material because it has a low theoretical capacity (e.g., about 372 mAh/g, or about 830 mAh/ml).

Thus, new high-capacity negative electrode materials were studied. Among them, a silicon-based material is known to have an excellent theoretical capacity of about 4 times per unit volume and 10 times per unit mass of existing carbon-based materials, and has an advantage that the potential difference from lithium is low and the reserves thereof are abundant, and, therefore, the silicon-based negative electrode material has attracted attention as a negative electrode material to replace carbon-based materials.

However, when the silicon-based negative electrode material is manufactured through a conventional batch process, there is a disadvantage in that it is difficult to reduce the oxygen content of the resulting silicon-based negative electrode material due to contact with an external air and others, resulting a low charging/discharging capacity, which limits battery performance, and the production cost is also high.

### DISCLOSURE

### Technical Problem

The present disclosure relates to a method for producing a negative electrode material for a secondary battery capable of improving electrochemical performance such as charging/discharging capacity in the secondary battery using a silicon oxide as a negative electrode material. Further, the present disclosure relates to a negative electrode material for a secondary battery produced by said method. Further, the present disclosure relates to a secondary battery.

### Technical Solution

In order to solve the above problems, the present disclosure provides a method for producing a negative electrode material for a secondary battery, comprising:

a gel-forming step of introducing SiCl₄ and then ethylene glycol into a reactor at a temperature of 0° C. to 25° C. under an inert atmosphere to form a gel;

a preheating step of heating the gel to a temperature of 200° C. to 500° C.; and
a heat treatment step of heating the gel subjected to the preheating step to a temperature of 500° C. to 1100° C. to form a silicon oxide.

Further, the gel-forming step may be performed under a nitrogen atmosphere.

Further, the gel-forming step may be performed at a temperature of 3° C. to 20° C.

Further, the preheating step may be performed at a temperature of 350° C. to 450° C.

Further, the preheating step may comprise jetting an inert gas to the gel at a pressure of 4 kgf/cm² to 6 kgf/cm².

Further, the inert gas in the preheating step may be argon.

Further, the heat treatment step may be performed at a temperature of 650° C. to 950° C.

Further, the heat treatment step may include jetting an inert gas to the gel at a pressure of 5 kgf/cm² to 7 kgf/cm².

Further, the inert gas in the heat treatment step may be nitrogen.

Further, the heat treatment step may consist of a plurality of heat treatment steps.

Further, the method may further comprise a cooling step of cooling the silicon oxide after the heat treatment step.

Further, the cooling step may use a halocarbon refrigerant.

In addition, the present disclosure also provides a negative electrode material for a secondary battery produced by any one of the above-described methods.

Moreover, the present disclosure also provides a secondary battery comprising the above-described negative electrode material for a secondary battery.

### Advantageous Effects

The present method can easily produce a negative electrode material for a secondary battery capable of providing a secondary battery having excellent electrochemical performance such as charging/discharging capacity.

### DESCRIPTION OF DRAWINGS

FIG. 1 is a schematic view of an in-line process of producing a negative electrode material for a secondary battery according to an embodiment of the present disclosure.

FIG. 2 is a schematic view of a cooling air supply unit for performing a cooling step according to an embodiment of the present disclosure.

FIG. 3 shows the results of an elemental analysis of a silicon oxide obtained by a method for producing a negative electrode material for a secondary battery according to an embodiment of the present disclosure using SEM.

### BEST MODE

In the following description, only parts necessary for understanding embodiments of the present disclosure will be described, and descriptions of other parts will be omitted so as not to obscure the gist of the present disclosure.

Also, terms and words used in the specification and the appended claims to be described below should not be construed in a limiting sense by conventional or dictionary meanings. The present disclosure should be interpreted in terms of meaning and concept consistent with the technical spirit thereof based on the principle that the inventor can properly define its own invention with a concept of terminology for explaining in the best way. Thus, the embodiments described in the present specification and the configurations shown in the drawings are merely preferred embodiments of the present disclosure and are not intended to exhaust all of the technical spirit of the present disclosure. It is, therefore, to be understood that the above embodiments and configurations may have various equivalents and variations that may be replaced at the time of filing the present disclosure.

The method for producing a negative electrode material for a secondary battery according to the present disclosure will be described in more detail with reference to the following embodiments.

<Gel-Forming Step>

First, the gel-forming step of reacting SiCl₄ with ethylene glycol will be described in detail.

In the gel-forming step, SiCl₄ is introduced into a reactor at a temperature of 0° C. to 25° C. under an inert atmosphere, followed by introducing ethylene glycol to form a gel containing an organosilicon compound. The gel obtained through the gel-forming step may be in the form of a sponge, and the organosilicon compound may be a single material or a mixture of a plurality of materials including a silicon, a carbon, an oxygen and a hydrogen. In addition to the forming of the organosilicon compound, a by-product gas may be generated. For example, H in ethylene glycol reacts with Cl in SiCl₄, so that hydrogen chloride (HCI) gas may be produced as a by-product. It is preferred that such by-product gas is discharged from the reactor. The method for discharging the by-product gas is not particularly limited, but a vent unit or the like may be used.

In the gel-forming step, the temperature of the reactor is 0° C. to 25° C., preferably 3° C. to 20° C., and more preferably 4° C. to 17° C. If necessary, a known temperature adjusting mechanism may be used in order to satisfy the above temperature range in the gel-forming step.

If the gel-forming step proceeds at a temperature higher than room temperature (25° C.) through heating or the like, a gel-forming reaction between SiCl₄ and ethylene glycol may not occur due to vaporization of a part of SiCl₄ or the like, and as a result, not forming a sponge-like gel, a liquid phase may be formed. In addition, if the gel-forming step proceeds at a temperature lower than 0° C., a by-product such as a hydrogen chloride gas may not be discharged smoothly in the gel-forming step.

The gel-forming step is carried out under an inert atmosphere, and the inert atmosphere is not particularly limited, but may be formed by injecting a nitrogen, a hydrogen, an argon, or a mixed gas thereof into the reactor. Among them, the inert atmosphere in the gel-forming step is preferably a nitrogen atmosphere.

When an inert gas is injected into the reactor to form an inert atmosphere, the pressure to be formed inside the reactor is preferably 0.5kgf/cm² or more and 1.5 kgf/cm² or less, and more preferably 0.8 kgf/cm² to 1.2 kgf/cm².

As the reactor, an open or closed reactor commonly used in the art can be used, but a closed reactor is preferably used. In the gel-forming step, the reactor is closed while SiCl₄ and ethylene glycol react to form a gel, thereby preventing the reactants and the product from contacting with an exterior air. As such, the oxygen content in the finally obtained silicon oxide can be lowered, and therefore, the battery performance such as charging/discharging capacity of a secondary battery produced using a silicon oxide can be improved.

There is no particular limitation as long as materials necessary for the reaction of SiCl₄ and ethylene glycol can be injected while the interior of the reactor is closed. For example, the reactor may have a connection pipe, and a gear pump may be provided to supply reactants in a predetermined amount through the connection pipe. Further, in order to prevent the reactants supplied through the connection pipe from flowing backward, a check valve may be provided. Further, in order to discharge gas such as hydrogen chloride gas or oxygen, which is a by-product in the gel-forming reaction, to the outside, the reactor may have a vent.

On the other hand, when the closed reactor or the like is used, the gel-forming step is preferably performed in an in-line process. For example, the closed reactor may be provided on a moving unit such as a conveyor belt, and it may be provided with a connection pipe to inject materials necessary for reaction such as SiCl₄ and ethylene glycol, and it may be provided with a vent so that gases such as hydrogen chloride gas and oxygen generated as a by-product in the gel-forming step can be discharged from it. As such, the gel-forming step can be performed while being blocked from the external air and moisture, thereby reducing the oxygen content in the finally obtained silicon oxide and improving the performance of the battery produced using the silicon oxide.

Further, if the step after the gel-forming step is also performed in an in-line process, as the closed reactor is transferred on a moving unit, the respective steps are sequentially proceeded, so that the entire reaction process can be effectively blocked from external air and moisture as compared with the batch mode. In addition, if the silicon oxide obtained from it is used as a negative electrode material to manufacture a battery, the electrochemical performance of the battery can be improved. However, the present disclosure is not limited thereto, and various structures, methods, and the like capable of performing an in-line process may be applied as long as each step can be performed in a continuous manner.

In addition, the gel-forming step may be carried out while stirring the reactor, and a stirrer commonly used in the art may be used for stirring, wherein the stirring speed is preferably 20 rpm to 150 rpm, more preferably 50 rpm to 100 rpm, and even more preferably 70 rpm to 90 rpm.

Meanwhile, when raw material is injected into the reactor, it is preferable to inject SiCl₄ first. If ethylene glycol is injected first and then SiCl₄ is injected, SiCl₄ has a low surface tension (0.0196 N/m at 25° C.), and SiCl₄ is likely to react abruptly only near the surface of ethylene glycol already injected into the reactor, which makes it difficult to perform uniform mixing and reaction in the gel-forming step. On the contrary, if ethylene glycol is injected after injecting SiCl₄ as in the present disclosure, the surface tension of ethylene glycol is higher (0.049 N/m at 25° C.) and ethylene glycol can reach the interior of SiCl₄, which makes uniform mixing and reaction in the gel-forming step, and also increased yield.

When reactants such as SiCl₄ and ethylene glycol are injected into the reactor, it is preferable to inject SiCl₄ into the reactor within 5 to 30 minutes, more preferably within 10 to 25 minutes, and even more preferably within 15 to 23 minutes. It is preferred that the ethylene glycol is injected into the reactor within 10 to 90 minutes, more preferably within 40 to 80 minutes, and even more preferably within 55 to 75 minutes, after completion of the injection of SiCl₄ to proceed the gel-forming reaction.

In this regard, if the ethylene glycol is rapidly injected for less than 10 minutes in the gel-forming step, the exothermic reaction proceeds drastically and the temperature below room temperature cannot be maintained in the gel-forming step, such that the yield of the gel obtained through the gel-forming step is lowered. In addition, if ethylene glycol is injected for more than 90 minutes, ethylene glycol in SiCl₄ or SiCl₄ in ethylene glycol may be completely dissolved due to the long-time reaction between SiCl₄ and ethylene glycol, such that the desired sponge-like (gel state) organosilicon compound may not be formed.

The total required time for the gel-forming step including the injection time of SiCl₄ and ethylene glycol is preferably from 70 minutes to 110 minutes, more preferably from 80 minutes to 100 minutes, and even more preferably from 85 minutes to 95 minutes. if the total required time is less than 70 minutes, the yield of the gel obtained through the gel-forming step is lowered, and a hydrogen chloride gas is abruptly generated, thereby damaging the manufacturing apparatus and the like. On the contrary, if the total required time exceeds 110 minutes, ethylene glycol in SiCl₄ or SiCl₄ in ethylene glycol may be completely dissolved due to the long-time reaction between SiCl₄ and ethylene glycol, such that the desired sponge-like (gel state) organosilicon compound may not be formed.

Further, the injection ratio of SiCl₄ and ethylene glycol is in the range of SiCl₄: ethylene glycol=2.5:1 to 1.5:1, preferably 2.3:1 to 1.7:1, and most preferably 2:1 in volume ratio. By injecting SiCl₄ and ethylene glycol in the above volume ratio, the yield of the gel is increased, and the problem that SiCl₄ is dissolved in an atmosphere containing a large amount of ethylene glycol and the organosilicon compound is not formed can be solved.

<Preheating Step>

The present disclosure includes a preheating step of heating the gel obtained through the gel-forming step at a temperature of 200° C. to 500° C.

In the preheating step, before the heat treatment step described later, the gel obtained through the gel-forming step is heated to a temperature of 200° C. to 500° C. to thermally decompose and remove a hydrogen chloride gas generated as a by-product and unreacted ethylene glycol, etc. The temperature of the preheating step is preferably 200° C. to 450° C., more preferably 250° C. to 450° C., still more preferably 300° C. to 450° C., still even more preferably 350° C. to 450° C., and especially preferably 350° C. to 400° C. If the temperature in the preheating step is lower than 200° C., the removal of ethylene glycol may not be easy, and if the temperature exceeds 500° C., solidification of the gel may proceed.

The present disclosure includes a preheating step of heating the gel obtained through the gel-forming step to a predetermined temperature before proceeding to the heat treatment step. Thereby, it is possible to remove by-product gas such as hydrogen chloride gas in advance and to suppress the damage of the manufacturing apparatus which may be caused by the by-product gas in the heat treatment step, and also to remove moisture and unreacted ethylene glycol, such that the battery performance such as charging/discharging capacity of the secondary battery manufactured using the finally obtained silicon oxide can be further improved.

Also, the preheating step is preferably carried out in an enclosed reactor while blocking the outside air and moisture in the same manner as in the gel-forming step described above and is preferably conducted in an inert atmosphere. The inert atmosphere in the preheating step is not particularly limited, but may be formed by injecting nitrogen, hydrogen, argon, or a mixed gas thereof into the reactor, and it is preferable to be performed in an argon atmosphere. Accordingly, the oxygen content in the finally obtained silicon oxide can be lowered, and the electrochemical performance of the battery such as charging/discharging capacity of the secondary battery manufactured using the silicon oxide can be improved.

When the inert gas is injected into the reactor to form an inert atmosphere, the pressure to be formed inside the reactor is preferably 0.5 kgf/cm² or more and 1.5 kgf/cm² or less, and more preferably 0.8 kgf/cm² to 1.2 kgf/cm².

In addition, it is preferable that the preheating step includes not only forming an inert atmosphere but also jetting an inert gas to the gel at a high pressure.

By jetting an inert gas to the gel obtained through the gel-forming step at a high pressure to give an impact, oxygen, moisture and the like present on the gel surface or the like can be more effectively removed, which further lowers the oxygen content in the finally obtained silicon oxide, compared with the case of simply heating in the above-mentioned temperature range and inert atmosphere, and further, the electrochemical performance of the battery such as charging/discharging capacity of the secondary battery manufactured using the silicon oxide can be further improved.

In the preheating step, the pressure of the inert gas jetted to the gel is preferably 4 kgf/cm²to 6 kgf/cm², more preferably 5 kgf/cm² to 5.5 kgf/cm², and still more preferably 5.1 kgf/cm² to 5.3 kgf/cm². By jetting an inert gas to the gel at the high pressure range above, the electrochemical performance of the battery such as charging/discharging capacity of the secondary battery manufactured using the silicon oxide can be further improved.

The kind of the inert gas jetted to the gel in the preheating step is not particularly limited, but may be nitrogen, hydrogen, argon or a mixed gas thereof, and argon gas is preferable.

The total preheating time is preferably 25 to 65 minutes, more preferably 30 to 50 minutes, and even more preferably 35 to 45 minutes. If the total preheating time is less than 25 minutes, the unreacted ethylene glycol is not sufficiently removed, which may lead to deterioration of the battery performance such as charging/discharging capacity of the secondary battery manufactured using a silicon oxide. In addition, if the total required time exceeds 65 minutes, the production speed and productivity may be deteriorated.

With respect to jetting an inert gas, after the gel-forming step is completed, it is possible to add a separate preparation step for inert gas jetting when the preheating step is started. For example, after performing a step of replacing with a reactor lid for jetting an inert gas, an inert gas may be jetted in the above-described predetermined pressure range. The replacement of the reactor lid can preferably be performed for 5 to 15 minutes, more preferably for 7 to 12 minutes, and it is preferable to replace the reactor lid while injecting the above-mentioned inert gas at the same pressure as in the gel-forming step. If a high-pressure inert gas is jetted before the replacement of the reactor lid is completed, there is a possibility that the gel (organosilicon compound) obtained through the gel-forming step is released in the reactor, such that the yield of silicon oxide obtained through the preheating step and/or the heat treatment step may be lowered.

<Heat Treatment Step>

The present disclosure includes a heat treatment step of heating the gel subjected to the preheating step to a temperature of 500° C. to 1100° C.

In the heat treatment step, the gel subjected to the preheating step is heated to a temperature higher than the preheating step to solidify (sinter) the gel while removing hydrogen, unreacted ethylene glycol and the like remaining in the gel through the preheating step, thereby forming a silicon oxide.

The temperature of the heat treatment step is preferably 550° C. to 1050° C., more preferably 600° C. to 1000° C., still more preferably 650° C. to 950° C., still even more preferably 700° C. to 900° C., and especially preferably 750° C. to 850° C. If the temperature of the heat treatment step is lower than 500° C., the solidification of the gel may not proceed, and if the heat treatment temperature is higher than 1100° C., excessive grain growth of the silicon oxide may occur due to excessive heat energy.

It is preferable that the heat treatment step is carried out while blocking external air and moisture in the closed reactor similarly to the gel-forming step and the preheating step described above, which can improve the performance of the battery by lowering the oxygen content in the finally obtained silicon oxide.

The heat treatment step may also include jetting an inert gas at a high pressure to the gel, as in the preheating step. By jetting an inert gas to the gel obtained through the preheating step at a high pressure to give an impact, oxygen and the like present on the gel surface or the like can be removed, which lowers the oxygen content in the finally obtained silicon oxide, and the electrochemical performance of the battery such as charging/discharging capacity of the secondary battery manufactured using the silicon oxide can be improved.

The pressure at the time when the inert gas is jetted in the heat treatment step is preferably 5 kgf/cm² to 7 kgf/cm², more preferably 5.5 kgf/cm² to 6.5 kgf/cm², and still more preferably 5.7 kgf/cm² to 6.3 kgf/cm².

The kind of the inert gas jetted to the gel in the heat treatment step is not particularly limited, but may be nitrogen, hydrogen, argon or a mixed gas thereof, and nitrogen gas is preferable. The total heat treatment time is preferably 100 to 130 minutes, more preferably 110 to 125 minutes, and even more preferably 115 to 120 minutes.

Meanwhile, when the method for producing a negative electrode material of the present disclosure is performed by an in-line process, the heat treatment step may be a single heat treatment step, but it is preferable to consist of a plurality of heat treatment steps, preferably three or more, more preferably four or more steps, and more preferably ten or fewer steps.

With respect to the in-line process, when the heat treatment in the heat treatment step is performed on a moving unit such as a conveyor belt, a temperature gradient may appear on the moving unit, and a uniform heat treatment may not occur in the gel inside the reactor, such that the hydrogen remaining in the gel subjected to the preheating step, the unreacted ethylene glycol and the like cannot be smoothly removed, and the performance of the secondary battery may be deteriorated. For example, gas may be generated due to a side reaction with the electrolyte of the secondary battery. In particular, when hydrogen is not completely removed, it may become difficult to suppress the expansion of the volume of silicon in the negative electrode material produced by the method for producing a negative electrode material for a secondary battery of the present disclosure, and therefore, making it difficult to improve the electrochemical characteristics of the secondary battery.

Therefore, in order to reduce the temperature gradient that may occur in the case of producing the negative electrode material of the present disclosure on a moving unit such as a conveyor belt, heat treatment may be divided into a plurality of independent sections, such that a uniform heat treatment can be performed on the gel inside the reactor.

<Cooling Step>

The method for producing a negative electrode material for a secondary battery of the present disclosure may further comprise a cooling step of cooling the reactor after the heat treatment step.

The method for cooling the reactor is not particularly limited, and ordinary air cooling, water cooling, or the like can be used. If necessary, the reactor can be rapidly cooled within 10 to 60 minutes in combination with a refrigerant. The silicon oxide obtained through the heat treatment step is cooled to 0° C. to 25° C. through the cooling step, and preferably cooled to 0° C. to 15° C.

The refrigerant refers to a material that is used in a cooling unit to perform a cooling function. For example, ammonia, sulfurous acid gas, halocarbon refrigerant and the like can be used. Of these, a halocarbon refrigerant is preferably used. As used herein, the halocarbon refrigerant indicates a refrigerant obtained by replacing hydrogen in methane and ethane with fluorine, chlorine or bromine, and may include at least one of chlorofluorocarbon (CFC), hydrochlorofluorocarbon (HCFC), and hydrofluorocarbon (HFC). In addition, it is preferable to use a CHClF₂ refrigerant, or instead of using the CHClF₂ refrigerant, it is also preferable to use a mixture of CH₂F₂ and CHF₂CF₃ in a ratio of 10:90 to 90:10, or use a mixture of CH₂F₂, CHF₂CH₃ and CH₂FCF₃ in a ratio of 1:1:1.

The cooling step of the present disclosure may also include, for example, jetting the air cooled by the refrigerant to the silicon oxide. Further, in the cooling step of the present disclosure, a separate cooling unit may be used for cooling the air by using the above-described refrigerant and cooling the silicon oxide by jetting the cooled air.

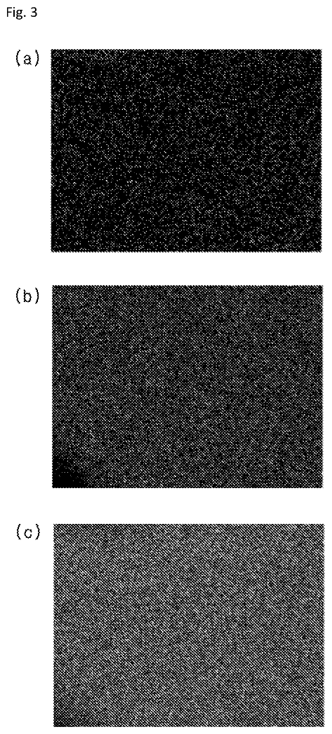

The cooling process used in the cooling step of the present disclosure is not particularly limited as long as it can cool the silicon oxide obtained through the heat treatment step. For example, the cooling air supply unit 5000 shown in FIG. 2 can be used. The cooling air supply unit 5000 shown in FIG. 2 is a unit capable of cooling a silicon oxide by cooled air. A cooling air supply part (not shown) is connected to the reactor. The cooling air supply part is connected to the cooling air supply unit 5000. The cooling air supply unit 5000 includes, a compressor (CR) for compressing a refrigerant, a pump (PP) for pumping the compressed refrigerant, a heat exchanger (HE) for cooling the air introduced into a cooling pipe (CP) using a refrigerant, the cooling pipe (CP) passing through the inside of the heat exchanger, and an air inlet (TB) for introducing air into the cooling pipe, and a refrigerant circulation pipe (RP) for interconnecting the compressor (CR), the pump (PP), and the heat exchanger (HE) and for moving the refrigerant.

Using the cooling air supply unit 5000 in FIG. 2, the refrigerant cooled by the compressor (CR) is pumped through the pump (PP) and supplied to the heat exchanger (HE). The refrigerant supplied to the heat exchanger (HE) expands in the process of cooling the air introduced into the cooling pipe (CP) through the air inlet (TB) to generate the cooling air. The expanded refrigerant is again introduced into the compressor (CR). Through repeating this process, cooling of the silicon oxide can proceed.

The cooling air supply part may have a plurality of nozzles spaced apart from each other. The cooling air cooled by the refrigerant is jetted into the reactor from the nozzles. The jetted cooling air can be discharged to the outside through a fan or the like after cooling the silicon oxide.

<In-Line Process>

The production method for the present disclosure may be carried out through an in-line process.

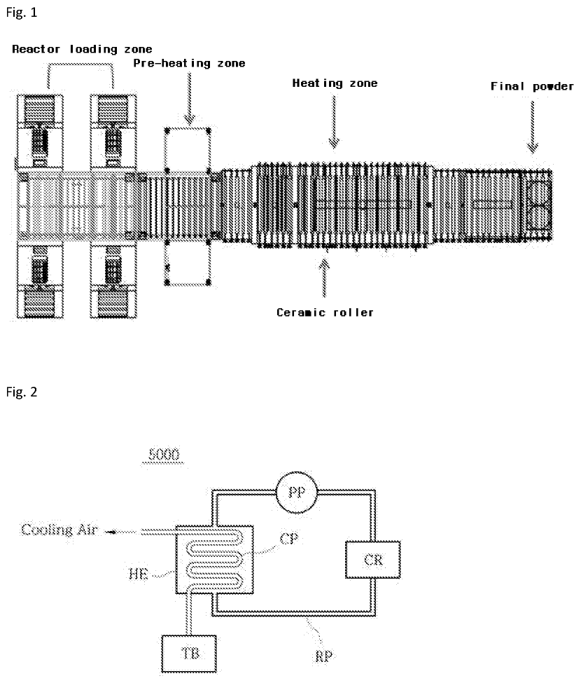

FIG. 1 is a schematic view of an in-line process of producing a negative electrode material for a secondary battery according to an embodiment of the present disclosure. When the units performing from the gel-forming step to the heat treatment step, or from the gel-forming step to the cooling step are carried out in connection by an in-line manner, for example, a reactor may be installed on a moving unit such as a conveyor belt, and each step may be performed while the reactor is being conveyed. In this case, the speed at which the reactor is conveyed on the moving unit may be adjusted to control the time required for each step. Through such in-line process, the introduction of external air, which may occur during the process of moving the reactor whenever the respective steps are completed to a position where the next step is performed as in the batch process, is suppressed and the reaction is performed in a closed state, such that the oxygen content in the obtained silicon oxide can be lowered, and the battery performance such as charging/discharging capacity of the secondary battery produced using the silicon oxide can be improved.

<Negative Electrode Material for Secondary Battery>

Hereinafter, a negative electrode material for a secondary battery of the present disclosure will be described in detail.

It is preferable that the negative electrode material for secondary battery produced through the production method comprising the gel-forming step to the heat treatment step of the present disclosure or the production method comprising the gel-forming step to the cooling step is carbon-containing silicon oxide (SiOₓ—C). At this time, it is preferable that the content of oxygen (x) in the silicon oxide is 0<x<2, more preferably 0.5≤x≤1.5, and still more preferably 0.8≤x≤1.2. That is, it is preferable that the oxygen content in the silicon oxide is low, so that the battery performance such as charging/discharging capacity of the secondary battery produced using the silicon oxide can be improved. In addition, the carbon-containing silicon oxide of the present disclosure may be a core-shell structure in which SiOₓ is surrounded by carbon, or a composite state in which spherical SiOₓ is surrounded by carbon particles.

FIG. 3 shows the results of an elemental analysis of silicon oxide obtained by a method for producing a negative electrode material according to an embodiment of the present disclosure using SEM.

In each of the SEM images of FIGS. 3(a) to 3(c), those indicated by white dots indicate carbon, oxygen and silicon in order. The SEM images indicate that the silicon oxide of the present disclosure contains carbon as well as silicon and oxygen, and through the ratio of the white dots in each SEM image, the abundance ratio of each element is found to be in order of silicon>oxygen>carbon.

On the other hand, in order to control the particle size of the produced silicon oxide and to use it in the production of a secondary battery, it is necessary to make the produced silicon oxide mass into a powder form. For this purpose, it is preferable to control the particle size of the produced silicon oxide mass through, for example, a ball mill process or the like. The ball used in the ball mill process may use a ZrO₂ ball. The ball diameter is preferably 1 to 10 mm, more preferably 3 to 6 mm. If the ball diameter is less than 1 mm, it is difficult to control the particle size due to the small crushing and compressive energy. If the diameter of the balls exceeds 10 mm, it is difficult to control the particle size 10 μm or below.

In addition to the ball mill process, the particle size may be controlled by pulverizing the silicon oxide mass by jetting gas at a speed of, for example, Mach 2 through a jet mill process. When the jet mill process is used, the milling time may be shortened to improve the productivity, and the desired particle size may be controlled more accurately and uniformly.

<Secondary Battery >

The secondary battery of the present disclosure includes a positive electrode, a negative electrode, an electrolyte, and a separator. The negative electrode includes a negative electrode material (hereinafter sometimes referred to as “negative electrode active material”) produced according to the present disclosure. Since the secondary battery of the present disclosure includes the negative electrode material for a secondary battery of the present disclosure as a negative electrode, the electrochemical performance such as charging/discharging capacity is excellent.

The secondary battery of the present disclosure can be applied to a conventional shape such as a coin type, a flat plate type, a cylindrical type, and a laminate type.

The positive electrode and the negative electrode may be produced using a conventional method known in the art. For example, each of the positive electrode active material (positive electrode material) and the negative electrode active material is mixed with a binder, a conductive material or the like to prepare an electrode slurry. The prepared electrode slurry is coated on the current collector, rolled and dried. At this time, optionally, a small amount of conductive material and/or binder may be added.

On the other hand, the electrode slurry requires a solvent to form the electrode, and the solvent to be used is not particularly limited, and includes, for example, organic solvents such as NMP (N-methyl pyrrolidone), DMF (dimethyl formamide), acetone, dimethyl acetamide and the like, or water. These solvents may be used alone or as a mixture of two or more thereof. The amount of the solvent used is sufficient provided that it can dissolve and disperse the electrode active material, the binder and the conductive material in consideration of the coating thickness of the electrode active material slurry, the production yield, and the like.

The positive electrode may include a positive electrode current collector and a positive electrode active material coated on one or both surfaces of the positive electrode current collector. The positive electrode active material may optionally include a conductive material and a binder.

The positive electrode current collector is for supporting the positive electrode active material and is not particularly limited as long as it has excellent conductivity and is electrochemically stable in the voltage range of the secondary battery of the present disclosure. For example, the positive electrode current collector may be any metal selected from the group consisting of copper, aluminum, stainless steel, titanium, silver, palladium, nickel, alloys thereof, and combinations thereof.

The positive electrode active material may vary depending on the use of the secondary battery, and a known material is used for the specific composition. For example, it may include lithium cobalt-based oxide, lithium manganese-based oxide, lithium copper oxide, lithium nickel-based oxide and lithium manganese composite oxide, lithium-nickel-manganese-cobalt-based oxide, or a mixture thereof.

The conductive material is a component for further improving the conductivity of the positive electrode active material, and may include, but is not limited to, graphite such as natural graphite or artificial graphite; carbon black such as carbon black, acetylene black, Ketjen black, channel black, furnace black, lamp black, and thermal black; conductive fibers such as carbon fiber and metal fiber; metal powders such as carbon fluoride, aluminum, and nickel powder; conductive whiskers such as zinc oxide and potassium titanate; conductive metal oxides such as titanium oxide; conductive materials such as polyphenylene derivatives, and the like.

The binder has a function of holding the positive electrode active material on the positive electrode current collector and organically connecting the positive electrode active materials. Examples of the binder include polyvinylidene fluoride (PVDF), polyimide (PI), polyvinyl alcohol (PVA), carboxymethylcellulose (CMC), starch, hydroxypropylcellulose, regenerated cellulose, polyvinylpyrrolidone, tetrafluoroethylene, polyethylene, polypropylene, styrene-butadiene rubber, fluororubber, and various copolymers thereof.

The negative electrode may include a negative electrode active material coated on one side or both sides of the negative electrode current collector as in the positive electrode. The negative electrode active material may include the negative electrode material produced by the present method, and optionally include a conductive material and a binder. The current collector, the conductive material and the binder are as described above.

The electrolyte includes lithium ions and is used for causing an electrochemical oxidation or reduction reaction at the positive electrode and the negative electrode through the electrolyte. The electrolyte may be a non-aqueous electrolyte or a solid electrolyte which does not react with the lithium metal, but is preferably a non-aqueous electrolyte, and includes an electrolyte salt and an organic solvent.

The electrolyte salt contained in the non-aqueous electrolyte is a lithium salt. The lithium salt can be used without limitation as long as it is commonly used in an electrolyte for a lithium secondary battery. For example, LiCl, LiBr, LiI, LiClO₄, LiBF₄, LiB₁₀Cl₁₀, LiPF₆, LiCF₃SO₃, LiCF₃CO₂, and the like can be used.

Examples of the organic solvent contained in the non-aqueous electrolyte include those commonly used in electrolytes for lithium secondary batteries, such as ether, ester, amide, linear carbonate, cyclic carbonate, etc., which can be used alone or in combination of two or more.

Examples of the ether compound include, but are not limited to, dimethyl ether and diethyl ether. Examples of the ester include, but are not limited to, methyl acetate, ethyl acetate, γ-butyrolactone and the like.

Specific examples of the linear carbonate compound include, but are not limited to, any one or a mixture of two or more selected from the group consisting of dimethyl carbonate (DMC), diethyl carbonate (DEC), ethyl methyl carbonate (EMC), methyl propyl carbonate, and ethyl propyl carbonate.

Specific examples of the cyclic carbonate compound include, but are not limited to, any one selected from the group consisting of ethylene carbonate (EC), propylene carbonate (PC), vinylene carbonate, vinyl ethylene carbonate, and halides thereof, or mixtures of two or more thereof. Examples of such halides include, but are not limited to, fluoroethylene carbonate (FEC) and the like.

The separator separates or insulates the positive electrode and the negative electrode from each other and enables transporting of lithium ions between the positive electrode and the negative electrode. Such separator may be made of a porous, non-conductive or insulating material. The separator may be an independent member such as a film, or a coating layer added to the positive electrode and/or the negative electrode.

Specifically, a porous polymer film, for example, a porous polymer film made of a polyolefin-based polymer such as an ethylene homopolymer, a propylene homopolymer, or an ethylene/butene copolymer may be used alone or in a laminated form, or a conventional porous nonwoven fabric such as a polyethylene terephthalate fiber may be used, but is not limited thereto.

### EXAMPLES

Hereinafter, examples of the present disclosure will be described in detail. The following examples are for the understanding of the present disclosure only and do not limit the technical spirit thereof.

### Example 1

Nitrogen was injected into a closed reactor at a pressure of 1 kgf/cm² and a flow rate of 34 to 35 L/min to form a nitrogen atmosphere in the reactor. After 20 L of SiCl₄ was introduced, 10 L of ethylene glycol was added and stirred at 90 rpm to form a gel (gel-forming step). The reaction temperature according to the reaction time in the gel-forming step was as shown in Table 1 below, and the total time required for the gel-forming step was 90 minutes.

TABLE 1

| Reaction | | |
|---|---|---|
| time | Temperature | Remarks |
| 0 min. | 16.4° C. | Temperature in the reactor at the start of the |
| | | reaction |
| 10 min. | 12.6° C. | After the SiCl₄ was introduced into the reactor |
| | | for 0 to 18 minutes, the addition of ethylene |
| | | glycol started and the reaction of SiCl₄ with |
| | | ethylene glycol proceeded |
| 20 min. | 14.5° C. | |
| 30 min. | 7.8° C. | |
| 40 min. | 4.1° C. | |
| 50 min. | 6.0° C. | |
| 60 min. | 5.7° C. | |
| 70 min. | 7.3° C. | |
| 80 min. | 7.9° C. | |

Next, the gel formed through the gel-forming step was heated at 400° C. for 40 minutes (preheating step), and then the gel subjected to the preheating step was heated again at a temperature of 800° C. for 120 minutes to thereby obtain 6.0 kg of carbon-containing silicon oxide (heat treatment step). Then, the air cooled through R404 (HFC refrigerant) was jetted to the silicon oxide and cooled to 2° C. (cooling step), and the total time required for the cooling step was 60 minutes. In the preheating step and the heat treatment step, an inert gas was jetted to the gel to give an impact under the conditions described in Table 2, while heating to the above-mentioned temperature. On the other hand, “Furnace 1-4” in Table 2 below indicates that the heat treatment step was divided into four independent sections. In the preheating step, the reactor cap was replaced before jetting argon gas at a pressure of 5.2 kgf/cm² to the gel obtained through the gel-forming step.

TABLE 2

| | | | | | | Processing | |
|---|---|---|---|---|---|---|---|
| | Process | Gas | Pressure | Flow rate | | time | Remarks |
| | Preheating | Argon | 1 kgf/cm² | 34~35 | L/min | 10 min. | Replacement of |
| | step | | | | | | reactor cap |
| | | Argon | 5.2 kgf/cm² | 350 | L/min | 30 min. | 5.2 times the |
| | | | | | | | atmospheric |
| | | | | | | | pressure |
| Furnace 1 | Heat | Nitrogen | 6 kgf/cm² | 200~210 | L/min | 120 min. | 6 times the |
| Furnace 2 | treatment | | 6 kgf/cm² | 200~210 | L/min | | atmospheric |
| Furnace 3 | step | | 6 kgf/cm² | 200~210 | L/min | | pressure |
| Furnace 4 | | | 6 kgf/cm² | 200~210 | L/min | | |

6.0 kg of the carbon-containing silicon oxide obtained through the preheating step, the heat treatment step and the cooling step was pulverized into a powder using a ZrO₂ ball having a diameter of 6 mm. 10 g of 6.0 kg of the silicon oxide powder thus obtained was mixed with acetylene black (conductive material) and polyimide (binder) at a weight ratio of 7.5:1:1.5. Then, the mixture was added to 12.0 ml of N-methyl-2-pyrrolidone as a solvent and mixed to prepare a negative electrode active material in the form of a slurry (solid content: 45.5 wt %). The negative electrode active material was applied to a copper foil current collector and dried to prepare a negative electrode. On the other hand, a lithium metal foil was used as the positive electrode, and as an electrolytic solution, LiPF₆ 1.3 M of ethylene carbonate (EC)/diethyl carbonate (DEC) was mixed at a ratio of 1:1, and 5% of fluoroethylene carbonate (FEC) was added, and thereby preparing a coin-shaped half-cell.

Using an oxygen nitrogen analyzer ON836 (manufactured by LECO. Co., Ltd), the oxygen content of the carbon-containing silicon oxide prepared above was measured after fitting by using a reference sample having an oxygen content of 25 wt %, through detecting the amount of oxygen released when 0.3 g of the carbon-containing silicon oxide sample prepared above was quantitatively measured and was melted at 2500° C. or higher.

With respect to the secondary battery produced using the carbon-containing silicon oxide, the charging capacity and the discharging capacity of the silicon oxide were measured with a cut-off voltage of 0.005 to 1.5 V and a charging/discharging current of 0.1 C using a charging/discharging unit WBCS3000S (manufactured by WonATech. Co., Ltd), and the charging/discharging efficiency was determined by dividing the measured discharging capacity by the measured charging capacity(discharging capacity/charging capacity).

The results of measuring the oxygen content of the carbon-containing silicon oxide and measuring the charging capacity, discharging capacity, and charging/discharging efficiency of the secondary battery produced using the carbon-containing silicon oxide are shown in Table 3 below.

### Example 2

This example was carried out in the same manner as in Example 1, except that argon was injected at a pressure of 1 kgf/cm² instead of jetting argon at a pressure of 5.2 kgf/cm² in the preheating step. The oxygen content, the charging capacity, the discharging capacity, and the charging/discharging efficiency of the carbon-containing silicon oxide and the battery prepared in Example 2 were measured in the same manner as in Example 1, and the results were shown in Table 3 below.

### Comparative Example 1

This example was carried out in the same manner as in Example 1, except that the heat treatment step was carried out immediately without the preheating step. The oxygen content, the charging capacity, the discharging capacity, and the charging/discharging efficiency of the carbon-containing silicon oxide and the battery prepared in Comparative Example 1 were measured in the same manner as in Example 1, and the results were shown in Table 3 below.

TABLE 3

| | Ex. 1 | | Ex. 2 | | C. Ex. 1 | |
|---|---|---|---|---|---|---|
| Oxygen content | 33.3 | wt % | 39.9 | wt % | 44.5 | wt % |
| Charging | 1965.4 | mAh/g | 1779.6 | mAh/g | 1590.5 | mAh/g |
| capacity | | | | | | |
| Discharging | 1148.5 | mAh/g | 965.3 | mAh/g | 800.0 | mAh/g |
| capacity | | | | | | |
| Charging/ | 60.8% | | 54.2% | | 50.3% | |
| discharging | | | | | | |
| efficiency | | | | | | |

As shown in Table 3, Examples 1 and 2, which were subjected to the heat treatment step after the preheating step, showed that the oxygen content of the carbon-containing silicon oxide was low, and charging capacity, discharging capacity and charging/discharging efficiency were high, compared with Comparative Example 1 in which the heat treatment step was carried out immediately without the preheating step. Further, Example 1 shows that the oxygen content of the silicon oxide finally obtained was further decreased as compared with Example 2 by jetting argon gas at a higher pressure of about 5.2 times the atmospheric pressure in the preheating step to give an impact on the gel obtained through the gel-forming step, and therefore, the charging capacity, the discharging capacity, and the charging/discharging efficiency of the finally produced battery were higher than those of Example 2.

1. A method for producing a negative electrode material for a secondary battery comprising:
a gel-forming step of introducing SiCl4 and then ethylene glycol into a reactor at a temperature of 0° C. to 25° C. under an inert atmosphere to form a gel;
a preheating step of heating the gel to a temperature of 200° C. to 500° C.; and
a heat treatment step of heating the gel subjected to the preheating step to a temperature of 500° C. to 1100° C. to form a silicon oxide.

2. The method of claim 1, wherein the gel-forming step is performed under a nitrogen atmosphere.

3. The method of claim 1, wherein the gel-forming step is performed at a temperature of 3° C. to 20° C.

4. The method of claim 1, wherein the preheating step is performed at a temperature of 350° C. to 450° C.

5. The method of claim 1, wherein the preheating step comprises jetting an inert gas to the gel at a pressure of 4 kgf/cm2 to 6 kgf/cm2.

6. The method of claim 5, wherein the inert gas is argon.

7. The method of claim 1, wherein the heat treatment step is performed at a temperature of 650° C. to 950° C.

8. The method of claim 1, wherein the heat treatment step comprises jetting an inert gas to the gel at a pressure of 5 kgf/cm2 to 7 kgf/cm2.

9. The method of claim 8, wherein the inert gas is nitrogen.

10. The method of claim 1, wherein the heat treatment step consists of a plurality of heat treatment steps.

11. The method of claim 1, further comprising a cooling step of cooling the silicon oxide after the heat treatment step.

12. The method of claim 11, wherein the cooling step uses a halocarbon refrigerant.

13. A negative electrode material for a secondary battery produced by the method according to claim 1.

14. A secondary battery comprising the negative electrode material for a secondary battery according to claim 13.
